(19) United States
(12) Patent Application Publication
(10) Pub. No.: US 2011/0187157 A1
(43) Pub. Date: Aug. 4, 2011

(54) VEHICULAR AIR-CONDITIONING DUCT STRUCTURE

(75) Inventors: Yasunobu Yamazaki, Okazaki-shi (JP); Toru Kondo, Toyoake-shi (JP)

(73) Assignee: Toyota Jidosha Kabushiki Kaisha, Toyota-Shi (JP)

(21) Appl. No.: 13/018,825

(22) Filed: Feb. 1, 2011

(30) Foreign Application Priority Data
Feb. 1, 2010 (JP) JP2010-020559

(51) Int. Cl. B61D 27/00

(52) U.S. Cl. 296/208

(57) ABSTRACT

A vehicular air-conditioning duct structure including: a first duct, provided behind an instrument panel, that communicates a first blowout port formed in the instrument panel with a delivery port of an air conditioner; a second duct downstream portion formed separately from a second duct main body portion provided behind the instrumental panel and connected to a downstream side of the second duct main body portion to thereby constitute a second duct that communicates a second blowout port formed in the instrument panel with the delivery port; a mounting portion that fixes the second duct downstream portion to a downstream side of the first duct; and a bridge portion that couples a portion of the first duct upstream of the mounting portion to the second duct main body portion and that is joined to a back face of the instrument panel.

### CROSS-REFERENCE TO RELATED APPLICATION

This application claims priority to Japanese Patent Application No. 2010-020559 filed on Feb. 01, 2010, which is incorporated herein by reference in its entirety including the specification, drawings and abstract.

### BACKGROUND OF THE INVENTION

1. Field of the Invention

The invention relates to a vehicular air-conditioning duct structure.

2. Description of the Related Art

A duct for a vehicular air conditioner is described in Japanese Patent Application Publication No. 11-123923 (JP-A-11-123923). In the duct for the air conditioner, the downstream side of an air-conditioner duct portion overlaps with the downstream side of a defroster duct portion in a vehicle vertical direction and the two sides are fixed to each other using a mounting portion.

Furthermore, in the duct for the air conditioner, the air-conditioner duct portion and the defroster duct portion are integrally formed through blow molding. In the integrally formed ducts, the upstream side of the air-conditioner duct portion is coupled to the upstream side of the defroster duct portion using a thin hinge. After having been formed in a deployed configuration, which allows the formed air-conditioner duct portion and the formed defroster duct portion to be removed from a die, the air-conditioner duct portion and the defroster duct portion are then bent into the above-described configuration of the duct for the air conditioner at the thin hinge.

However, in the duct for the air conditioner described in JP-A-11-123923, burrs are formed on the thin hinge during blow molding. Due to the burrs, a bending load with respect to a deployment direction may thus be applied to the air-conditioner duct portion and the defroster duct portion. In this case, a peeling load is applied in such a direction as to peel off the mounting portion that fixes the downstream sides of the air-conditioner duct portion and the defroster duct portion to each other. Therefore, the strength of the mounting portion is needed. As a result, the production costs are increased.

Furthermore, when this type of duct for the air conditioner is integrally formed through blow molding, a deterioration in yield rate may be caused. In this case as well, production costs are increased.

### SUMMARY OF INVENTION

The invention provides a vehicular air-conditioning duct structure that may be produced without increasing production costs.

A first aspect of the invention relates to a vehicular air-conditioning duct structure that includes: a first duct, provided behind an instrument panel, that communicates a first blowout port formed in the instrument panel with a delivery port of an air conditioner; a second duct main body portion provided behind the instrumental panel, that is away from the first duct; a second duct downstream portion formed separately from the second duct main body portion and connected to a downstream side of the second duct main body portion to thereby constitute a second duct that communicates a second blowout port formed in the instrument panel with the delivery port; a mounting portion that fixes the second duct downstream portion to a downstream side of the first duct; and a bridge portion that couples a portion of the first duct upstream of the mounting portion to the second duct main body portion and that is joined to a back face of the instrument panel.

According to the vehicular air-conditioning duct structure according to the foregoing first aspect of the invention, the second duct downstream portion is formed separately from the second duct main body portion. Accordingly, for example, even if the second duct downstream portion overlaps with the first duct in a vehicle vertical direction, there is no need to couple the upstream side of the first duct to the upstream side of the second duct through a thin hinge as in the case of the related art in order to arrange the first duct and the second duct according to the configuration of the air-conditioning duct. Thus, a bending load may be restrained from being applied to the first duct and the second duct in a deployment direction. Therefore, the application of the peeling load to the mounting portion, which fixes the second duct downstream portion to the downstream side of the first duct, may be restrained.

Further, the portion of the first duct upstream of the mounting portion is coupled to the second duct main body portion by the bridge portion, and the mounting rigidity of the second duct with respect to the first duct is thus ensured. Accordingly, the peeling load may be further restrained. Owing to the foregoing, there is no need to excessively increase the strength of the mounting portion. Therefore, production costs are reduced.

Furthermore, the bridge portion is joined to the back face of the instrument panel, and the mounting rigidity of the first duct and the second duct with respect to the instrument panel is thus ensured. Accordingly, for example, the first duct and the second duct may be formed thinly. Therefore, production costs may be further reduced.

Further, as described above, the second duct downstream portion is formed separately from the second duct main body portion. Therefore, it is easy to mold the air-conditioning duct, and the yield rate in molding the air-conditioning duct may be improved. Accordingly, production costs may be reduced as well.

In the aforementioned vehicular air-conditioning duct structure, the first duct may extend in a vehicle width direction, and the bridge portion may be provided at a midway portion of the first duct in the vehicle width direction.

According to this vehicular air-conditioning duct structure, the bridge portion is provided at the midway portion of the first duct in the vehicle width direction. Therefore, sufficient rigidity of the first duct along its entire length in the vehicle width direction may be ensured.

In the aforementioned vehicular air-conditioning duct structure, the mounting portions may be provided on both sides of the second duct in a direction perpendicular to a length direction of the second duct downstream portion.

According to this vehicular air-conditioning duct structure, the mounting portions are provided on both the sides of the second duct in the direction perpendicular to the length direction of the second duct downstream portion. Therefore, the second duct downstream portion may be fixed to the downstream side of the first duct in a balanced manner.

The aforementioned vehicular air-conditioning duct structure may further includes; a convex fitting portion formed on one of an upstream side of the second duct downstream portion and a downstream side of the second duct main body portion; and a concave fitted portion, formed on the other of the upstream side of the second duct downstream portion and the downstream side of the second duct main body portion, into which the fitting portion is inserted.

According to this vehicular air-conditioning duct structure, the fitting portion may be inserted to the fitted portion when fitting. Accordingly, for example, even if the length dimensions of the first duct and the second duct varies, the variation may be absorbed by adjusting the degree by which the fitting portion is inserted into the fitted portion.

In the aforementioned vehicular air-conditioning duct structure, the bridge portion may be provided at a downstream side of the second duct main body portion.

According to this vehicular air-conditioning duct structure, the bridge portion is provided at the downstream side of the second duct main body portion, and the rigidity on the downstream side of this second duct main body portion is thus ensured. Therefore, the operability in fitting the fitting portion to the fitted portion is improved.

### BRIEF DESCRIPTION OF THE DRAWINGS

The features, advantages, and technical and industrial significance of this invention will be described in the following detailed description of an example embodiment of the invention with reference to the accompanying drawings, in which like numerals denote like elements, and wherein:

FIG. 1 is an exploded perspective view of an air-conditioning duct to which a vehicular air-conditioning duct structure according to one embodiment of the invention is applied, an instrument panel, a register, and an air conditioner;

FIG. 2 is an enlarged exploded plan view of a portion of the air-conditioning duct shown in FIG. 1; and

FIG. 3 is an enlarged plan view showing how a portion of the air-conditioning duct shown in FIG. 1 is molded by means of a family mold.

### DETAILED DESCRIPTION OF EMBODIMENT

One embodiment of the invention will be described hereinafter with reference to the drawings.

It should be noted that arrows UP, FR, and OUT shown in the drawings indicate the upper side in a vehicle vertical direction, a front side in a vehicle longitudinal direction, and an outer (right) side in a vehicle width direction respectively.

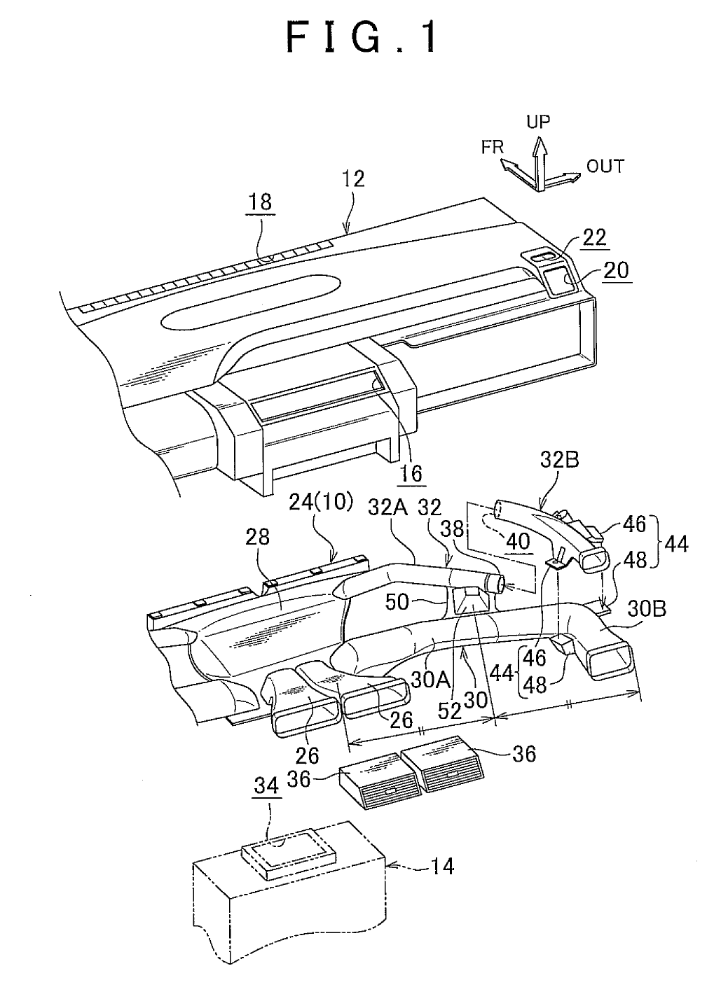

An instrument panel 12 shown in FIG. 1 is provided in a front portion of a passenger compartment. The instrument panel 12 is mounted on an instrument panel reinforcement laid so as to extend between a right front pillar (not shown) and a left front pillar (not shown), and covers an air conditioner 14 and the like from the upper side of the vehicle.

A center face blowout port 16 and a center defroster blowout port 18 are formed in the central portion of the instrument panel 12. A side face blowout port 20 that serves as a first blowout port and a side defroster blowout port 22 that serves as a second blowout port are formed near the outer edge of the instrument panel 12. Further, the side face blowout port 20 and the side defroster blowout port 22 are formed alongside of each other in the vehicle vertical direction.

An air-conditioning duct 24 is provided behind the instrument panel 12. A vehicular air-conditioning duct structure 10 according to the embodiment of the invention is used as the air-conditioning duct 24.

That is, the air-conditioning duct 24 includes center face ducts 26, a center defroster duct 28, a side face duct 30 that serves as a first duct, and a side defroster duct 32 that serves as a second duct.

The center face ducts 26 and the center defroster duct 28 extend in the vehicle longitudinal direction, and upstream sides of the respective ducts communicate with a delivery port 34 formed in the air conditioner 14. In addition, the downstream sides of the center face ducts 26 communicate with the center face blowout port 16 via registers 36 respectively, and the downstream side of the center defroster duct 28 communicates with the center defroster blowout port 18.

In contrast, the side face duct 30 and the side defroster duct 32 extend in the vehicle width direction, and communicate the delivery port 34 with the side face blowout port 20 and the side defroster blowout port 22 respectively.

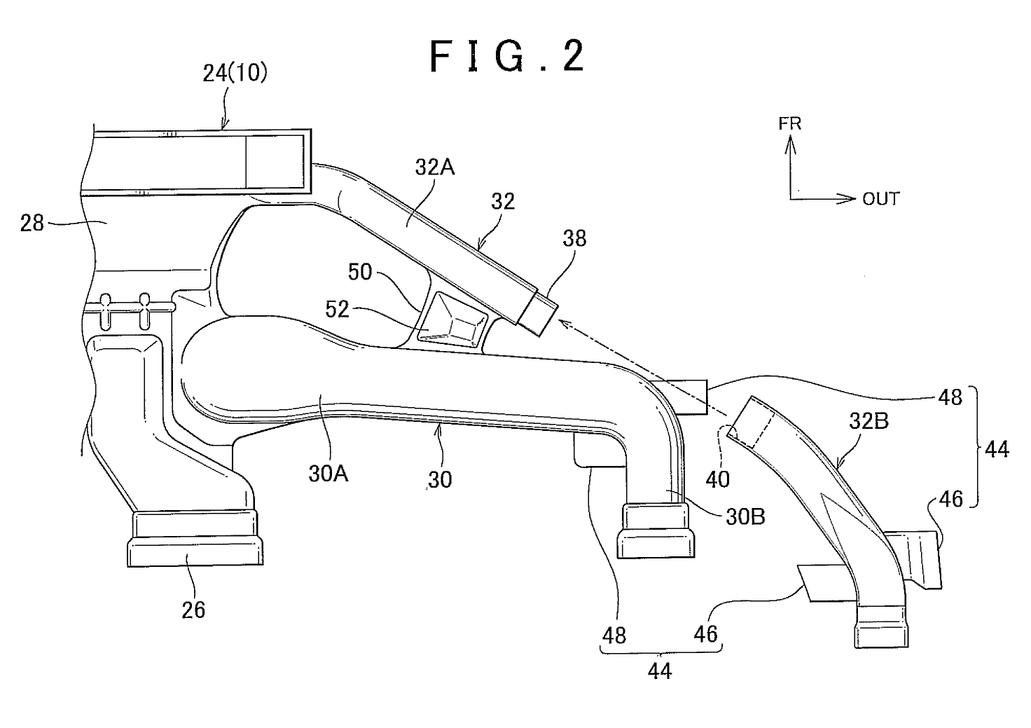

Further, as shown in FIGS. 1 and 2, the side defroster duct 32 is composed of a main body portion 32A functioning as a second duct main body portion, and a downstream portion 32B, formed separately from this main body portion 32A, that serves as a second duct downstream portion.

The main body portion 32A is provided away from the main body portion 30A of the side face duct 30 in the vehicle longitudinal direction. The downstream portion 32B is provided above the downstream portion 30B of the side face duct 30 so as to overlap with the downstream portion 30B of the side face duct 30.

Further, a convex fitting portion 38 is formed on a downstream from the main body portion 32A, and a concave fitted portion 40 is formed upstream side of the downstream portion 32B.

The fitting portion 38 is inserted into the fitted portion 40 when fitted, and the downstream portion 32B is thereby connected to the main body portion 32A. It should be noted that the degree by which the fitting portion 38 is inserted into the fitted portion 40 when fitted may be adjusted.

Further, a pair of mounting strips 46 are formed on a downstream side of the downstream portion 32B. The mounting strips 46 are formed on both sides of the downstream portion 32B (both sides across the downstream portion 32B) in a direction perpendicular to a length direction of the downstream portion 32B. In addition, a pair of mounting seats 48 are formed on a downstream side of the side face duct 30 at positions that match the pair of the mounting strips 46.

Together with the mounting strips 46, the mounting seats 48 constitute mounting portions 44. Each mounting strip 46 may be welded to the respective mounting seats 48, for example, to fix the downstream portion 32B to the downstream side of the side face duct 30.

Further, the side face duct 30 is coupled to the downstream side of the main body portion 32A through a bridge portion 50 at a midway portion along the length (that is, a midway portion in the vehicle width direction) of side face duct 30 upstream of the mounting portions 44. The bridge portion 50 is laid so as to extend between the midway portion along the length of side face duct 30 upstream of the mounting portions 44 and the downstream side of the main body portion 32A. Furthermore, a joint portion 52 that protrudes upward is formed on the bridge portion 50.

As shown in FIG. 1, the joint portion 52 and other joint portions (not shown) may be, for example, welded to the back face of the instrument panel 12 so as to join the air-conditioning duct 24 to the back face of the instrument panel 12.

It should be noted that the air-conditioning duct 24 may be formed through, for example, sheet blow molding or vacuum molding.

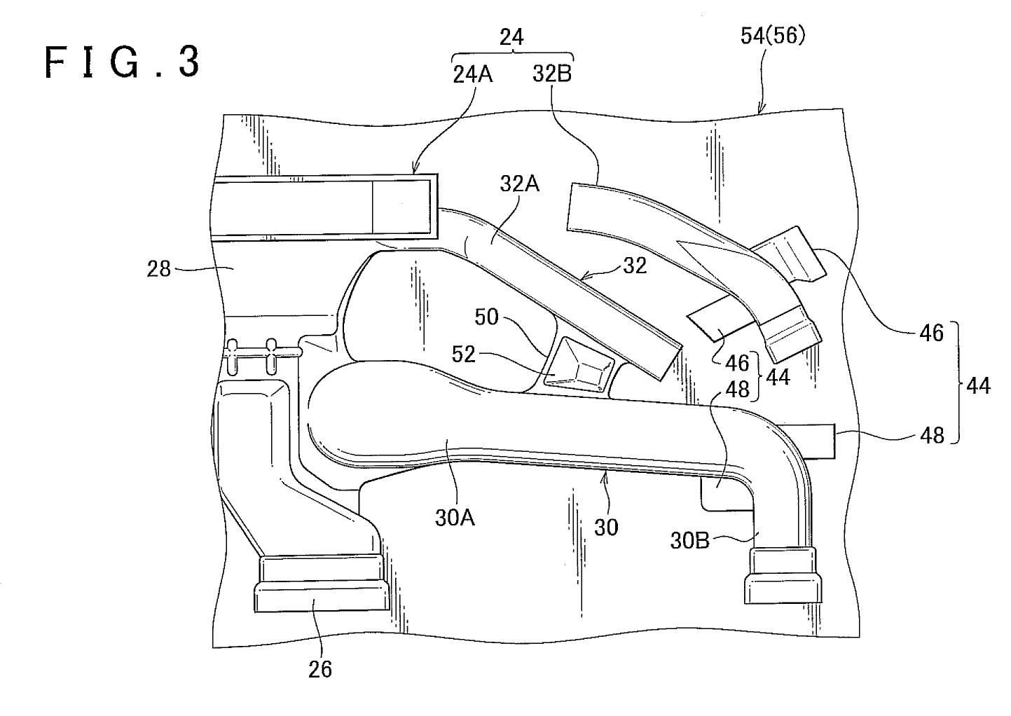

Further, as shown in FIG. 3, the downstream portion 32B is molded, simultaneously with a main body portion 24A of the air-conditioning duct 24 other than the downstream portion 32B, by means of a common mold 54 (i.e., molded by means of a so-called family mold). It should be noted that the lower mold (core) of the mold 54 is shown in FIG. 3, and that the upper mold (cavity) of the mold 54 is not shown in FIG. 3.

Next, the operation and effect of the embodiment of the invention will be described.

As shown in FIGS. 1 and 2, according to this vehicular air-conditioning duct structure 10, the downstream portion 32B of the side defroster duct 32 is formed separately from the main body portion 32A. Accordingly, for example, even if the downstream portion 32B is overlaps with the downstream portion 30B of the side face duct 30 in the vehicle vertical direction, there is no need to couple the upstream side of the side face duct 30 to that of the side defroster duct 32 a thin hinge, as in the case of the related art, in order to arrange the side face duct 30 and the side defroster duct 32 according to the configuration of the air-conditioning duct 24.

Thus, a bending load may be restrained from being applied to the side face duct 30 and the side defroster duct 32 in a deployment direction. Therefore, the application of the peeling load to the mounting portions 44, which fix the downstream portions 32B and 30B to each other, may be restrained.

Further, the portion of the side face duct 30 located upstream of the mounting portions 44 is coupled to the main body portion 32A by the bridge portion 50. The mounting rigidity of the side defroster duct 32 with respect to the side face duct 30 is thus ensured. Accordingly, the peeling load to the mounting portions 44 may be further restrained. Accordingly, there is no need to excessively increase the strength of the mounting portions 44. Therefore, the production costs are reduced.

Furthermore, the bridge portion 50 is joined to the back face of the instrument panel 12 to ensure the mounting rigidity of the side face duct 30 and the side defroster duct 32 with respect to the instrument panel 12. Accordingly, for example, the side face duct 30 and the side defroster duct 32 may be formed thinly. Therefore, production costs may be further reduced.

In addition, the downstream portion 32B may be formed separately from the main body portion 32A. Therefore, it is easy to mold the air-conditioning duct 24, and the yield rate in molding the air-conditioning duct 24 may be improved. Accordingly, production costs may be reduced as well.

In particular, the downstream portion 32B may be molded, simultaneously with the main body portion 24A of the air-conditioning duct 24 other than the downstream portion 32B, by means of the common mold 54 (i.e., molded by means of the so-called family mold). Therefore, production costs may be further reduced.

In addition, the fitting portion 38 may be inserted into the fitted portion 40 when fitted. Accordingly, for example, even if the length dimensions of the side face duct 30 and the side defroster duct 32 varies, the variation may be absorbed by adjusting the degree by which the fitting portion 38 is inserted into the fitted portion 40.

The bridge portion 50 is coupled to the downstream side of the main body portion 32A, near the fitting portion 38, to ensure sufficient rigidity near the fitting portion 38. Therefore, the operability in fitting the fitting portion 38 to the fitted portion 40 may be improved.

Furthermore, the bridge portion 50 is provided at the midway portion along the length of the side face duct 30. Therefore, sufficient rigidity of the side face duct 30 along its entire length may be ensured. Thus, the operability in joining the mounting strips 46 to the mounting seats 48 may be improved, in addition to improving the operability in fitting the fitting portion 38 to the fitted portion 40.

Further, the mounting portions 44, composed of the mounting strips 46 and the mounting seats 48, are provided on both the sides of the downstream portion 32B in the direction perpendicular to the length direction of the downstream portion 32B. Therefore, the downstream portion 32B may be fixed to the downstream portion 30B in a balanced manner.

Next, modified examples of the embodiment of the invention will be described.

In the above embodiment of the invention, the main body portion 32A and downstream portion 32B of the side defroster duct 32 are formed as separate components, and the main body portion 30A of the side face duct 30 is integrally formed with the downstream portion 30B of the side face duct 30. Alternatively, the main body portion 30A and downstream portion 30B of the side face duct 30 may be formed as separate components, with the main body portion 32A of the side defroster duct 32 integrally formed with the downstream portion 32B of the side defroster duct 32.

It should be noted that the side defroster duct 32 serves as the first duct of the invention, and that the side face duct 30 serves as the second duct of the invention.

Further, in the above embodiment of the invention, the convex fitting portion 38 and the concave fitted portion 40 are shown formed on the main body portion 32A and in the downstream portion 32B, respectively. However, the concave fitted portion may alternatively be formed in the main body portion 32A, and the convex fitting portion may alternatively be formed on the downstream portion 32B.

The above-described embodiment of the air-conditioning duct 24 is formed through sheet blow molding or vacuum molding. However, the air-conditioning duct 24 may be formed using other methods of formation.

Although an embodiment of the invention has been described above, it is obvious that the invention is not limited to the described embodiment, and that particular embodiments may be further modified without departing from the scope of the invention.

What is claimed is:

1. A vehicular air-conditioning duct structure comprising:
a first duct, provided behind an instrument panel, that communicates a first blowout port formed in the instrument panel with a delivery port of an air conditioner;
a second duct main body portion provided behind the instrumental panel, that is away from the first duct;
a second duct downstream portion formed separately from the second duct main body portion and connected to a downstream side of the second duct main body portion to thereby constitute a second duct that communicates a second blowout port formed in the instrument panel with the delivery port;
a mounting portion that fixes the second duct downstream portion to a downstream side of the first duct; and
a bridge portion that couples a portion of the first duct upstream of the mounting portion to the second duct main body portion and that is joined to a back face of the instrument panel.

2. The vehicular air-conditioning duct structure according to claim 1, wherein
the first duct extends in a vehicle width direction, and
the bridge portion is provided at a midway portion of the first duct in the vehicle width direction.

3. The vehicular air-conditioning duct structure according to claim 1, wherein
the mounting portions are provided on both sides of the second duct in a direction perpendicular to a length direction of the second duct downstream portion.

4. The vehicular air-conditioning duct structure according to claim 2, wherein
the mounting portions are provided on both sides of the second duct in a direction perpendicular to a length direction of the second duct downstream portion.

5. The vehicular air-conditioning duct structure according to claim 1, further comprising:
a convex fitting portion formed on one of an upstream side of the second duct downstream portion and a downstream side of the second duct main body portion; and
a concave fitted portion, formed on the other of the upstream side of the second duct downstream portion and the downstream side of the second duct main body portion, into which the fitting portion is inserted.

6. The vehicular air-conditioning duct structure according to claim 2, further comprising:
a convex fitting portion formed on one of an upstream side of the second duct downstream portion and a downstream side of the second duct main body portion; and
a concave fitted portion, formed on the other of the upstream side of the second duct downstream portion and the downstream side of the second duct main body portion, into which the fitting portion is inserted.

7. The vehicular air-conditioning duct structure according to claim 3, further comprising:
a convex fitting portion formed on one of an upstream side of the second duct downstream portion and a downstream side of the second duct main body portion; and
a concave fitted portion, formed on the other of the upstream side of the second duct downstream portion and the downstream side of the second duct main body portion, into which the fitting portion is inserted.

8. The vehicular air-conditioning duct structure according to claim 5, wherein
the bridge portion is provided at a downstream side of the second duct main body portion.

9. The vehicular air-conditioning duct structure according to claim 1, wherein
the second duct main body portion is away from an upstream side of the first duct in a vehicle longitudinal direction, and
the second duct downstream portion overlaps with the downstream side of the first duct in a vehicle vertical direction.
